(19) United States
(12) Patent Application Publication
(10) Pub. No.: US 2013/0000040 A1
(43) Pub. Date: Jan. 3, 2013

(54) Reclining Mobility Chair And Method Of Use

(76) Inventors: Edward Conley, Camden, NY (US); Tamara Yager, Camden, NY (US)

(21) Appl. No.: 13/171,775

(22) Filed: Jun. 29, 2011

(51) Int. Cl. A61G 7/02; A47C 21/08; A61G 7/015

(52) U.S. Cl. 5/604

(57) ABSTRACT

A reclining mobility chair comprising a bed including a front end and a back end, a seat cushion resting above a central portion of the bed. The reclining mobility chair includes a back support attached to move from a horizontal position to a vertical position. Further elements include a set of lifts affixed beneath the bed, to raise and lower the bed, a housing attached beneath the set of lifts, where the housing controls the reclining mobility chair to move into a plurality of positions, and a set of wheels attached to said housing. Finally the reclining mobility chair includes a commode opening positioned within a central portion of the bed, beneath the seat cushion, and a commode attached beneath the commode opening wherein the commode enables the user to pass bodily fluids while seated upon the reclining mobility chair.

### BACKGROUND OF THE INVENTION

1. Field of the Invention

The present invention relates to an assistance chair similar to a powered wheelchair to enable a user to move through a plurality of positions, to transport the user from one location to another and to enable the user to relieve himself while seated upon the chair.

2. Description of Related Art

Powered wheelchairs are common items in nursing homes, hospitals and at the homes of elderly individuals or those with physical disabilities. The powered wheelchairs enable the user to easily transport from one location to another either with limited or no assistance from a caretaker, nurse or family member. These chairs are convenient for transportation but are limited in their mobility options. For example, conventional powered wheelchairs do not raise and lower to better adjust the user's height while sitting at a table or pulling up to another person in a chair. Likewise, the powered wheelchairs do not typically recline to offer a place for the user to rest or sleep. Also, conventional powered wheelchairs do not provide the ability for a user to easily relieve themselves while seated without using incontinence pads or diapers.

Accordingly, some enhancements have been made upon the conventional powered wheelchair. For example U.S. Pat. No. 7,585,019 by Alfred Huang discloses a seat reclining mechanism for a power wheelchair. The power wheelchair implements an actuator and a plurality of linkage mechanisms to move a seat, back portion and footrest simultaneously into a reclined position. While this invention does enable the powered wheelchair to recline it does not raise and lower the chair nor does it provide a method for the user to relieve themselves while sitting.

Alternatively, U.S. Patent Application No. 2001/0010099 by Kathryn Shero discloses a multi-function, comfort wheel chair wherein the wheelchair positions into a relined position. The wheelchair includes a seat with a bedpan attached beneath the seat to enable the user to use relieve themselves while seated. The wheelchair reclines and offers a way to dispose of bodily waste but it does not include the ability to adjust the height of the chair.

It would be beneficial in the art to provide a powered wheelchair that reclines, adjusts in height and provides a way for the user to relieve themselves while remaining seated in the chair.

### SUMMARY OF THE INVENTION

An object of the present invention is to provide a powered wheelchair that reclines from an upright position into a reclined position, includes a set of lifts to adjust the height of the chair and provides a commode attached below a seat cushion to enable the user to expel bodily waste when necessary without leaving the chair.

In view of the foregoing disadvantages inherent in the prior art, the purpose of the present disclosure is to provide a reclining mobility chair comprising a bed including a front end and a back end and a seat cushion resting above a central portion of the bed. The reclining mobility chair includes a back support attached to move the back support from a horizontal position to a vertical position. Further elements include a set of lifts affixed beneath the bed to raise and lower the bed, a housing attached beneath the set of lifts, where the housing controls the reclining mobility chair to move into a plurality of positions, and a set of wheels attached to said housing. Finally the reclining mobility chair includes a commode opening positioned within a central portion of the bed, beneath the seat cushion, and a commode attached beneath the commode opening wherein the commode enables the user to pass bodily waste while seated upon the reclining mobility chair.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a side view of a reclining mobility chair in an upright position in accordance with an exemplary embodiment of the present invention;

FIG. 2 depicts a side view of a reclining mobility chair in a reclined position in accordance with an exemplary embodiment of the present invention;

FIG. 3 depicts a backside view of a reclining mobility chair in accordance with an exemplary embodiment of the present invention; and

FIG. 4 depicts a top view of a reclining mobility chair in accordance with an exemplary embodiment of the present invention.

Like reference numerals refer to like parts throughout the description of several views of the drawings.

### DETAILED DESCRIPTION OF THE DRAWINGS

The present invention relates to an assistance chair similar to a powered wheelchair to enable a user to move through a plurality of positions, to transport the user from one location to another and to enable the user to release bodily waste while seated upon the chair. The present invention discloses a reclining mobility chair as a way to offer mobility to elderly and physically challenged individuals to enable them to conveniently move about their homes, a hospital, a nursing home and the like. The reclining mobility chair is a mobility seating apparatus configured to move between two major positions, an upright position and a reclined position. The reclining mobility chair is equipped with a centrally located commode opening and a commode positioned beneath the commode opening to enable the user to release bodily waste while sitting in the chair. Additionally, the reclining mobility chair may assist a caretaker when transferring the user onto a bed because the chair includes a set of lifts to raise and lower the user to the height of the bed. The reclining mobility chair offers the users a better feeling of freedom as they transition between activities with limited or no assistance from a nurse, caretaker or family member.

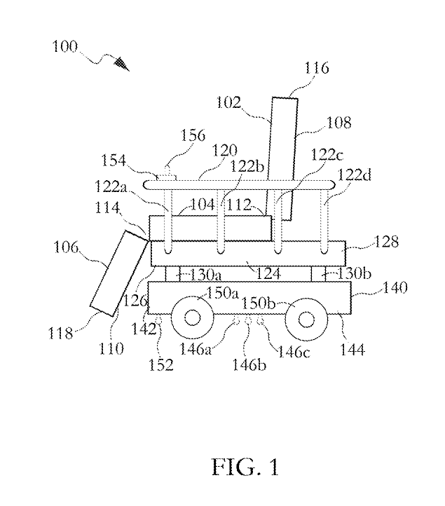

Turning now descriptively to the drawings, referring to FIG. 1, a side view of a reclining mobility chair (100) is shown in accordance with an exemplary embodiment of the present invention. The reclining mobility chair (100) adjusts from an upright position (as shown) to a reclined position. The reclining mobility chair (100) may include a back cushion (102), a seat cushion (104) and a leg cushion (106). The back cushion (102) may rest against a back support (108), and provide support for the back and head of a user. The back support (108) may move between a vertical position (as shown) to a horizontal position and a plurality of angles there between, in turn moving the back cushion (102) with it.

The seat cushion (104) may remain stationary in a horizontal position beneath the user or at a slight pitch to ensure the user remains upon the seat cushion (104). Also, the seat cushion (104) is removable from between the back cushion (102) and the leg cushion (106).

The leg cushion (106) may be attached to a leg support (110) at an opposite end of the seat cushion (104) from said back cushion (102). The leg cushion (106) may provide a soft resting spot for the user's legs and feet. The leg support (110) may move between a bent position (as shown) to an extended position and a plurality of angles there between, also moving the leg cushion (106) with it. The back support (108) and the leg support (110) move independent from each other, thus providing a greater number of positions for the user to enjoy. In another particular embodiment, the leg cushion (106) may include a footrest extending the leg cushion (106).

For additional comfort a set of sheets may be placed above the cushions (102, 104, 106). The set of sheets may prevent friction between the user's skin and the outer surface of the cushions (102, 104, 106) thus preventing friction burns or bed sores. Additionally, the cushions (102, 104, 106) may be stuffed with a foam or a memory foam material. The stuffing may offer comfort while still providing support for the user while using in the reclining mobility chair (100).

The back cushion (102) and the seat cushion (104) meet at a first junction (112), whereas the seat cushion (104) and the leg cushion (106) meet at a second junction (114). The first junction (112) and the second junction (114) may have enough flexibility between the cushions (102, 104 and 106) so as to enable the back support (108) and the leg support (110) to move freely without the cushions (102, 104, and 106) interfering with the range of motion. The first junction (112) may constrict the back cushion (102) and the seat cushion (104) the most when the back support (108) is in the vertical position and then release how tight the two cushions (102 and 104) are touching when the back support (108) is in the horizontal position. Likewise, when the seat cushion (104) and the leg cushion (106) are in the bent position the second junction (114) may not be as tight as when the leg support (110) raises to the extended position.

A bed (124) supports the seat cushion (104), and braces the back support (108) when in the horizontal position. The bed (124) may extend from a front end (126) to a back end (128). The front end (126) may reach just beneath the second junction (114), and the back end (128) may end more than half way up the back support (108). The back end (128) of the bed (124) may protrude far enough beneath the back support (108) and back cushion (102) as to offer a sufficient amount of support while still not extending far enough to interfere with the mobility and transport options of the reclining mobility chair (100).

To ensure that the user does not fall from the cushions (102, 104, and 106), a rail (120) or armrest may be positioned along the sides of the reclining mobility chair (100). The rail (120) may extend from the front end (126) of the bed (124) to the back end (128) to protect the user while in both the upright position and the reclined position. The rail (120) may be attached to the bed (124) by a plurality of support member (122a, 122b-122n). The plurality of support members (122a, 122b-122n) may be a plurality of beams, bars, plats or the like, which are strong and sturdy enough to hold the rail (120) in place. The rail (120) may secure the user upon the cushions (102, 104 and 106) and provide them with an adjustment bar to shift their position. When transferring the user from the reclining mobility chair (100) to a bed or a mattress the rail (120) may be lowered as to not interfere with movement of the user. In one particular embodiment, the rail (120) may be place in three alternative positions: 1) completely up; 2) halfway up; or 3) completely down. The complete up position prevents the patient from failing out of the chair (100). The halfway position allows for the patient more lateral movement so that a patient may enjoy a meal while sitting in the chair (100). The down position allows a caregiver to remove the patient from the chair (100).

Turning attention now further down the reclining mobility chair (100) may be a housing (140). The housing (140) may include a front portion (142) and a back portion (144). The housing (140) may contain a plurality of mechanical components to enable the reclining mobility chair (100) to move. The plurality of mechanical components may be electrically powered through conventional control systems for the movement of any levers, pistons and/or pumps that may be implemented to enable the use of the mobility chair (100). Sufficient space may also be provided in the housing (140) for storing supplies such as bags, toilet paper, cleaning supplies and the commode seat.

Between the housing (140) and the bed (124) may be a set of lifts (130a, 130b). The set of lifts (130a, 130b) may be air-hydraulic, electrical pistons or a similar lift type commonly known and used in the wheelchair lifting art. The set of lifts (130a, 130b) may lift and lower the bed (124) from a lowered position (as shown) to a raised position thus altering the height of seat cushion for the user. The set of lifts (130a, 130b) may enable the user to adjust to various heights while seated or reclined, thus allowing for more customized and comfortable positioning. For example, the user may raise or lower the set of lifts (130a, 130b) in the seated position depending on the height of a table to enable the user to eat, read, use a computer or the like. Likewise, in the reclined position the user may be lifted to the height of the bed for easy access to lift and shift the user onto the mattress.

The movement of the reclining mobility chair (100) may be controlled by using a set of pedals (146a, 146b, 146c) extending from a side portion of the housing (140). A first pedal (146a) controls the downward motion of the front lifts (130a) and a second pedal (146b) controls downward motion of rear lifts (130b) to control the height of the reclining mobility chair (100). The pedals (146a, 146b) may be depressed simultaneously to lower all lifts and pedal 146c raises all lifts with a pumping action.

Grip release handles at the top of the back support (108) are used to maneuver the back support (108) and leg support (110). The user squeezes the handles to release, lock and position the back support (108) and leg support (110), where the back support (108) and leg support (110) operate in conjunction with each other. The user simply releases the handles to lock the back and foot rests in place.

To enable the reclining mobility chair (100) to transport from one location to another may be a set of wheels (150a, 150b) attached to a bottom portion of the bed (140). The set of wheels (150a, 150b) may be motorized and controlled by the power source within the housing (140). Beneath the front portion (142) of the bed (140) may be a directional wheel (152) or swivel wheel to better control how the set of wheels (150a, 150b) turn. Furthermore wheels (150a) may also swivel for mobility purposes. The wheels (150a) may be set back from the front portion (142) 6-8 inches for maneuvering corners, where the wheels (150a, 150b) are relatively large 6-7 inches in diameter. Lower leg rests may also be provided to stabilize the chair (100) when a patient desires to stand from the chair (100).

Finally, attached to the rail (120) may be a controller (154). The controller (154) may enable the user to control the various functions of the reclining mobility chair (100), i.e., the lifts (130a, 130b), the back support (108), the leg support (110) and the set of wheels (150a, 150b). Upon the controller (154) may be a joystick to control the directional movement of the set of wheels (150a, 150b). Alternatively, a keypad may be attached to the controller with separate keys to control each function of the reclining mobility chair (100).

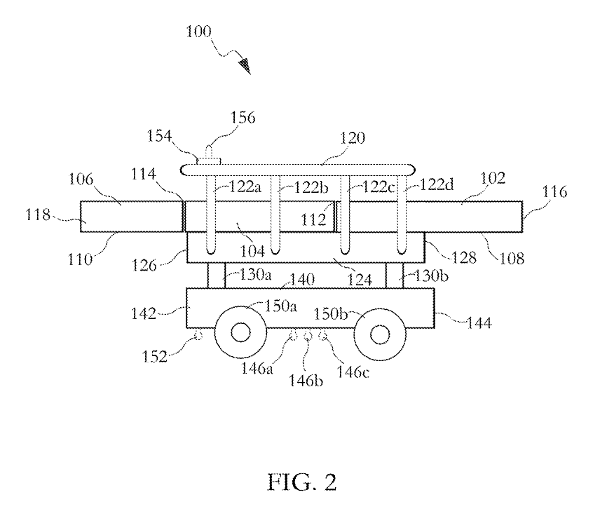

Referring now to FIG. 2, a side view of the reclining mobility chair (100) is shown in a vertical position in accordance with an exemplary embodiment of the present invention. The vertical position illustrates the reclining mobility chair (100) to resemble a gurney or hospital bed, because the back support (108) is in the horizontal position and the leg support (110) is in the extended position. The user may rest or sleep on top of the cushions (102, 104 and 106) with support from the sides by the rail (120). The back end (128) of the bed (124) is illustrated extending to a mid-portion of the back support (108). The back end (128) provides the structural support beneath the back support (108) while in the horizontal position.

FIG. 2 also illustrates the set of lifts (130a, 130b) in the raised position, but the reclining mobility chair (100) is not limited to remain in the raised position while in the reclined position. All of the control features are independent thus the back support (108), the leg support (110), the set of lifts (130a, 130b) all move independently without any linkage connecting the positioning of the other components.

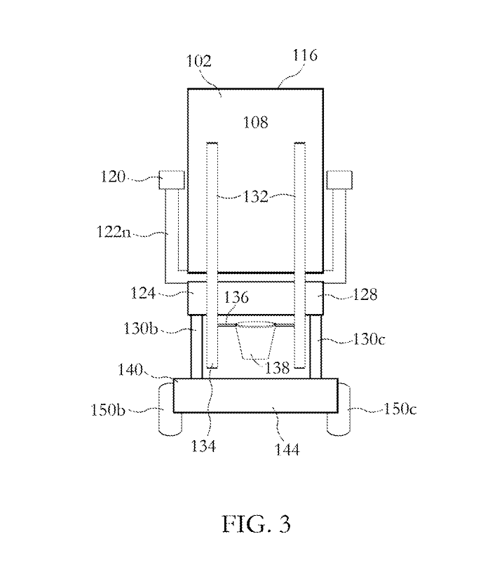

Referring to FIG. 3, a back view of the reclining mobility chair (100) is shown in accordance with an exemplary embodiment of the present invention. Along the back support (108) may be a set of back bars (132) which reach up to the mid-portion of the back support (108) and extend down to the bed (124). The set of back bars (132) enable the back support (108) to raise and lower from the vertical position to the horizontal position. The set of back bars (132) may be fastened to a mechanism within the bed (124), which mechanically moves the set of back bars (132) around a pivot within the bed (124) to raise and lower the back support (108).

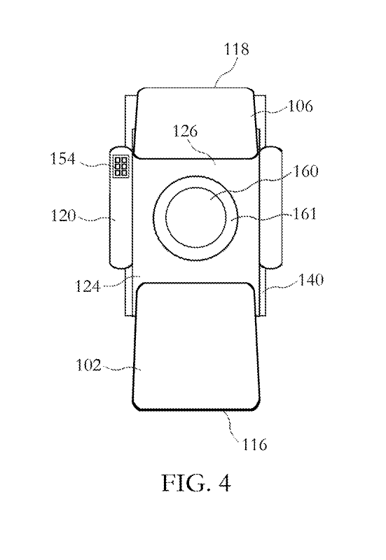

Extending beneath the bed (124) may be a set of rails (134) with a guide track (136). In this particular embodiment, the set of rails (134) and the guide track (136) uphold a commode (138). The commode (138) enables the user to urinate and defecate through a commode opening (described in FIG. 4) located in a central portion of the bed (124). The commode (138) slides along the guide track (136) between the set of rails (134) to enable the person to empty the contents of the commode (138) after use. As an option, a disposable bag may be placed within the commode (138) to allow for easier cleanup and disposal of any bodily waste expelled from the user.

Referring to FIG. 4 a top view of the reclining mobility chair (100) is shown in accordance with an exemplary embodiment of the present invention. The commode opening (160) is illustrated within the central portion of the bed (124). The commode opening (160) may be positioned directly beneath the seat cushion (104), therefore while sitting and sleeping the seat cushion (104) completely covers the commode opening (160). When use as a waste receptacle is necessary, the seat cushion (104) is removed to reveal the commode opening (160) and enable the user to expel bodily waste. A small lip (161) may be provided around the commode opening (160) so that the user may firmly sit over the commode opening (160). Further a pad may be provided around the commode opening (160) within the small lip (161). The controller (154) is illustrated as a keypad along the rail (120). The keypad includes a plurality of buttons to control all of the movements of the reclining mobility chair (100). The commode opening (160) should be large enough to encompass the opening within the seat frame to insure all waste goes into the commode.

To use the reclining mobility chair (100) as a toilet or waste receptacle a series of steps may be followed. First, the user or person may adjust the reclining mobility chair (100) into the reclined position. Next, the person rolls the user onto their side, braced against the rail (120). The person then removes the set of sheets, if in position above the cushions (102, 104, 106), and then removes the seat cushion (104). The user is then rolled back onto the bed (124) above the commode opening (160). The user or the person may raise the back support (108) and back cushion (102) into the vertical position, if necessary, and move the leg support (110) and the leg cushion (106) into the bent position so that the user sits comfortably above the commode opening (160) in the upright or seated position. After use, the person reclines the reclining mobility chair (100) into the reclining position, rolls the user to their side, replaces the seat cushion (104), rolls the user back onto their back, and then adjusts the user to their preferred position on the reclining mobility chair (100). Finally, the person simply removes the commode (138) from the set of rails (134) and the guide track (136), disposes of any bodily waste and then replaces the cleaned commode (138) for a subsequent use.

The reclining mobility chair (100) provides the user with the ability to use a single chair for a plurality of purposes. The user may sit, recline, sleep, work, transport, lift and lower etc. within the reclining mobility chair (100). With the range of motion and ability for transport the user is provided with greater mobility and easier transfers onto a bed within their home, nursing homes, hospitals and the like. Accordingly, the caretakers, nurses, and family members may prevent injury to themselves by not exerting as much effort or strain on their bodies when lifting, lowering and generally assisting the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A reclining mobility chair comprising:
a bed, where said bed includes a front end and a back end;
a seat cushion resting above a central portion of said bed, where said seat cushion is removable;
a back support attached above said back end of said bed, where said back support moves from a horizontal position to a vertical position;
a leg support extending from said front end of said bed, where said leg support moves from a bent position to an extended position;
a set of lifts affixed beneath said bed, where said lifts raise and lower said bed from a lower position to a raised position;
a housing attached beneath said set of lifts, where said housing contains a plurality of components to enable said reclining mobility chair to move into a plurality of positions;
a set of wheels attached to said housing, where said set of wheels enable said reclining mobility chair to move from one location to another;
a commode opening positioned within a central portion of said bed, beneath said seat cushion; and
a commode attached beneath said commode opening wherein said commode enables the user to pass bodily fluids while seated within said reclining mobility chair.

2. The reclining mobility chair according to claim 1, wherein said back support includes a back cushion attached to move when said back support moves and said leg support includes a leg cushion to move when said leg support moves.

3. The reclining mobility chair according to claim 1, wherein said bed includes a rail attached with a plurality of support members extending from said front end to said back end.

4. The reclining mobility chair according to claim 1, where said plurality of positions ranges from an upright position wherein said back support is in said vertical position and said leg support is in said bent position, to a reclined position wherein said back support is in said horizontal position and said leg support is in said extended position.

5. The reclining mobility chair according to claim 4, wherein said housing includes a set of pedals to control movement of said reclining mobility chair to move from said upright position to said reclined position.

6. The reclining mobility chair according to claim 5, wherein said set of pedals includes a first pedal, a second pedal and a third pedal.

7. The reclining mobility chair according to claim 6, wherein said first pedal controls the downward motion of front lifts and the second pedal controls downward motion of rear lifts to control the height of the reclining mobility chair, where the first pedal and second pedal may be depressed simultaneously to lower all lifts and the third pedal raises all lifts with a pumping action.

8. The reclining mobility chair according to claim 1, wherein said commode includes a disposable bag to dispose of said bodily fluids.

9. The reclining mobility chair according to claim 1, wherein said housing includes a directional wheel to direct how said reclining mobility chair turns and pivots.

10. The reclining mobility chair according to claim 1, wherein said rail includes a controller to enable the user to control movement of said reclining mobility chair into said plurality of positions.

11. The reclining mobility chair according to claim 10, wherein said controller comprises a joystick.

12. The reclining mobility chair according to 10, wherein said controller comprises a keypad with a set of keys.

13. A method of use for a reclining mobility chair comprising the steps of:
moving said reclining mobility chair into a reclined position;
rolling a user positioned on a set of cushions upon said reclining mobility chair onto a side of the user;
removing a seat cushion from beneath the user;
rolling the user over a commode opening within a central portion of said reclining mobility chair; and
moving said reclining mobility chair into an upright position to enable the user to defecate into a commode attached beneath said commode opening.

14. The method of use for the reclining mobility chair according to claim 13 further comprising the step of removing said commode for cleansing.

15. The method of use for the reclining mobility chair according to claim 13 further comprising the steps of:
moving said reclining mobility chair into said reclined position;
rolling the user onto said side; and
replacing said seat cushion.

16. The method of use for the reclining mobility chair according to claim 13 further comprising the step of moving said reclining mobility chair into said upright position.
